(19) United States
(12) Patent Application Publication
(10) Pub. No.: US 2014/0289268 A1
(43) Pub. Date: Sep. 25, 2014

(54) SYSTEMS AND METHODS OF RATIONING DATA ASSEMBLY RESOURCES

(71) Applicant: Salesforce.com, Inc., San Francisco, CA (US)

(72) Inventors: Vijay S. Patil, Fremont, CA (US); Brajendra Kumar Bhujabal, San Ramon, CA (US)

(73) Assignee: SALESFORCE.COM, INC., San Francisco, CA (US)

(21) Appl. No.: 14/015,969

(22) Filed: Aug. 30, 2013

Related U.S. Application Data
(60) Provisional application No. 61/804,934, filed on Mar. 25, 2013.

(51) Int. Cl. G06F 17/30

(52) U.S. Cl. CPC G06F 17/30867
USPC 707/765

(57) ABSTRACT

The technology disclosed relates to identifying unmet demands of users within the context of contact data search. In particular, it relates to identifying those search criteria that, upon being executed on an on-demand system, generate an overall number of search results below a threshold value. The threshold value can represent the real-world based expected value for the number of search results that should have been returned. The expected value can be a relative numerical estimate of the statistical likelihood of certain attributes within population sizes of contacts responsive to the search criteria. Operators of the on-demand system can be alerted to secure additional contacts that meet the search criteria and fulfill the demand for search results.

### RELATED APPLICATION

The application claims the benefit of U.S. provisional Patent Application No. 61/804,934, entitled, “System and Method for Contact Hunting,” filed on Mar. 25, 2013. The provisional application is hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed inventions.

The technology disclosed relates to identifying unmet demands of users within the context of contact data search. In particular, it relates to identifying those search criteria that, upon being executed on an on-demand system, generate an overall number of search results below a threshold value. The threshold value can represent the real-world based expected value for the number of search results that should have been returned. The expected value can be a relative numerical estimate of the statistical likelihood of certain attributes within population sizes of contacts responsive to the search criteria. Operators of the on-demand system can be alerted to secure additional contacts that meet the search criteria and fulfill the demand for search results.

Contact searching across business data repositories is a popular web application. However, current contact retrieval systems are limited in their applications and functionality. As the number of available documents and the access to information continues to increase, contact retrieval systems will need to respond to meet new and changing demands.

Accordingly, it is desirable to provide systems and methods that offer a flexible approach to rationing of data assembly resources. An opportunity arises to meet evolving customer demands for assembling new contacts that meet measured demands. Improved customer experience and engagement and higher customer satisfaction and retention may result.

### SUMMARY

The technology disclosed relates to identifying unmet demands of users within the context of contact data search. In particular, it relates to identifying those search criteria that, upon being executed on an on-demand system, generate an overall number of search results below a threshold value. The threshold value can represent the real-world based expected value for the number of search results that should have been returned. The expected value can be a relative numerical estimate of the statistical likelihood of certain attributes within population sizes of contacts responsive to the search criteria. Operators of the on-demand system can be alerted to secure additional contacts that meet the search criteria and fulfill the demand for search results.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 shows an example environment of rationing data assembly resources.

FIG. 2 is one implementation of a message sequence chart of rationing data assembly resources.

FIG. 3 illustrates a customer interface of searching contacts across a contact provider.

FIG. 4 shows one implementation of a plurality of objects that can be used for rationing data assembly resources.

FIG. 5 illustrates a flowchart of one implementation of rationing data assembly resources.

FIG. 6 is a flowchart of one implementation of identifying a new prototype query criteria.

FIG. 7 is a block diagram of an example computer system of rationing data assembly resources.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

The technology disclosed relates to rationing of data assembly resources for use in a computer-implemented system. The technology disclosed can be implemented in the context of any computer-implemented system including a database system, a multi-tenant environment, or the like. Moreover, this technology can be implemented using two or more separate and distinct computer-implemented systems that cooperate and communicate with one another. This technology may be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

Search results that do not meet user expectations, either because they cannot meet the search criteria provided by users or are deficient in terms of quantity and variety, are usually left unattended to by existing contact retrieval systems. These systems lack the functionality to automatically follow up on contact searches that do not produce any or, considerable number of contacts.

The technology disclosed automatically identifies gaps in coverage of a contact retrieval system relative to demand for contact retrieval. In effect, it determines that contacts not found in the contact retrieval system are likely to exist in the real-world, which may be purchased or proactively assembled from other contact repositories by solicitation, by contests, or other avenues. Identification of such contacts is triggered by search queries that received that yield inadequate results. In one implementation, the search criteria can identify the job functions and work locations of the contacts along with the industry codes of the companies for which the contacts work.

The technology disclosed can identify those search criteria for which the number of contacts retrieved is below an expected number of contacts in the real world. Such search criteria can be referred to as “low recall search criteria.” The expected value for number of responsive contacts can be based on the number of local companies in the geographic area that have the industry codes specified in the search criteria or on the number of employees of the companies having the queried job functions. An expected value can be inferred from a number of queries received, reasoning that demand and supply are likely to be in balance for much of the time.

The expected value of result size can also be based on the frequency of unique queries with low recall search criteria. When the number of low recall search criteria exceed a threshold value, the technology disclosed can identify them as “high demand search criteria.” The technology disclosed can further aggregate contacts that meet the high demand search criteria from other sources such as Internet and real-world data drives and campaigns. It can then automatically populate the contact retrieval system with the newly aggregated contacts.

The expected value of the result size for a search criteria can also be determined by the joint probability distribution of the number of local companies in the geographic area that have the industry codes specified in the search criteria or on the number of employees of the companies having the queried job functions. A population sample, such as the annually published “Statistical Abstract of the United States,” is used to estimate the distribution of search criteria in the entire population. This population sample includes a wide variety of information based on the census as well as other data intelligence sources. For instance, the expression P (Chicago, 56, Vice-President) denotes an estimation of the number of individuals working in the Chicago region as vice-presidents for the industry assigned an industry code of 56.

### Rationing Environment

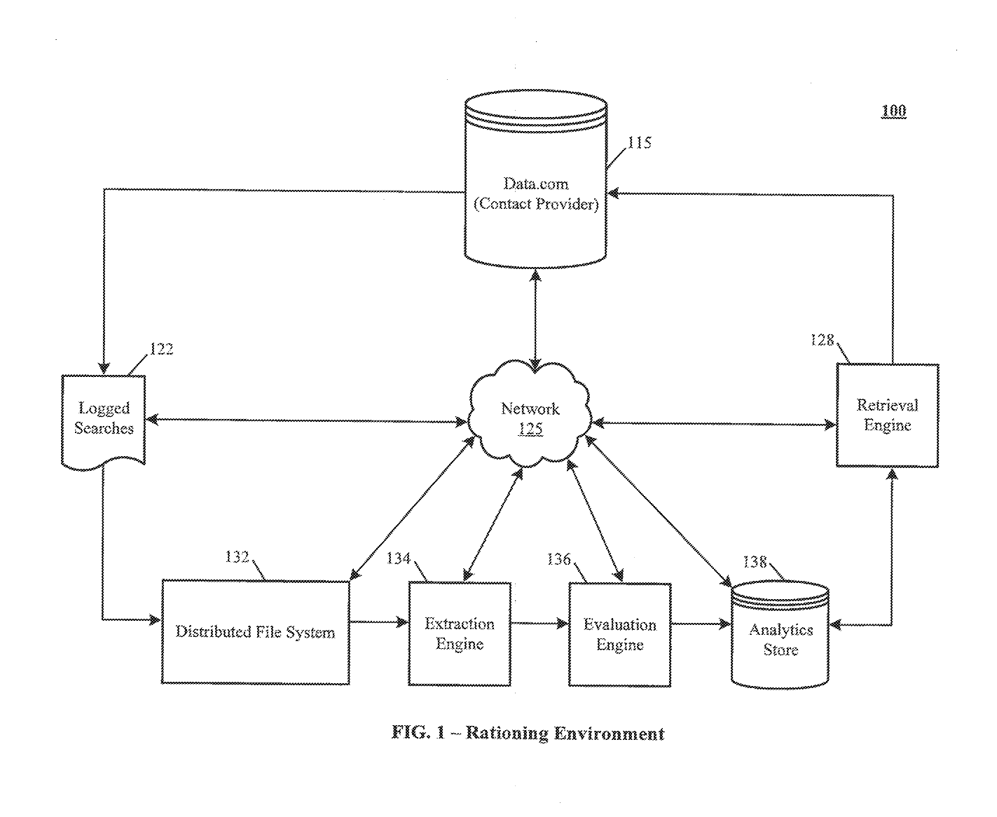

FIG. 1 shows an example environment 100 of rationing data assembly resources. FIG. 1 shows that environment 100 can include a contact provider 115 such as Data.com provided by Salesforce.com, logged searches 122 and analytics store 138. FIG. 1 also includes a distributed file system (DFS) 132, extraction engine 134, evaluation engine 136, and retrieval engine 128. In other implementations, environment 100 may not have the same elements as those listed above and/or may have other/different elements instead of, or in addition to, those listed above. The different elements can be combined into single software modules and multiple software modules can run on the same hardware.

In some implementations, the engines can be of varying types including workstations, servers, computing clusters, blade servers, server farms, or any other data processing systems or computing devices. In other implementations, the data stores can be relational database management systems (RDBMSs), object oriented database management systems (OODBMSs), or any other data storing systems or computing devices instead or addition of distributed file system (DFS) 132.

Contact provider 115 can serve as an electronic business directory of companies and business professionals that holds user generated contact databases. It can also serve as a cloud based data tracking service through which a user can query one or more contact databases. If any relevant records are found, the user can perform a field-by-field comparison to determine which information should be imported. In one implementation, contact provider 115 can include a contact repository such as Dun & Bradstreet and provide contact information aggregated and crowd sourced from many different users and sources.

When the contact provider 115 is searched to determine contacts based on a user specified search criteria, a trigger function can be executed that sends a message to one or more contact databases. The message can include the information that was entered by the user. The one or more contact databases can use this information as the basis of a search for related documents. For example, information entered by the user can include a first name, last name, job title, and company name. In one implementation, the information can include one or more data values that include the text words that were entered by the users. In another implementation, the information can also include identifiers generated based on a data field in which the information was entered. For example, a form can have an identifier associated with a data field that is configured to receive a first name. If a data value is entered into that field, the identifier can be associated with the data value and identify it as a first name.

Contact provider 115 can also use the information provider by users to formulate a search strategy and a query to identify and retrieve relevant data objects. In one implementation, relevant data objects can be identified based on matching data values. For example, if a first name provided by a user matches a first name stored in a record in the contact provider 115, that record can be identified as relevant, and retrieved. Thus, a field-by-field comparison can be made based on information entered into the new record and information stored in records in contact provider 115. If one or more data objects, such as a first name, last name, email, phone number, mailing address, standard industrial classification (SIC) number, or annual revenue, matches a search criteria, then the record that stores the matching data value can be returned as a result of the query. Furthermore, data value provided by the user can be compared with account names and metadata associated with records in addition to the contents of the records themselves.

A user specified search can specify at least one role associated with an organization, an organization name or an organization type. For instance, a user can specify searches based on job titles or functions, company names, company types, industry codes, or any combination of these searches. In one implementation, the role associated with an organization can be based at least in part on a determination made by an algorithm associated with a contact database. For example, contact provider 115 can assign a role such as “chief technology officer” to different individuals with different titles in different organizations based on an analysis of each organization's hierarchy of job titles.

Contact provider 115 can also record search queries and maintain search logs. In one implementation, the search logs can be stored as logged searches 122 that include entries of semi-structured queries, the time the queries were submitted to the contact provider 115 and the Internet Protocol (IP) addresses of the clients that submitted the queries or cookie values that identify the clients. In another implementation, the logged searches 122 can include semi-structured data such as search logs, web pages, logs of page views, click streams, RSS (Rich Site Summary) feeds, application logs, application server logs, system logs, transaction logs, sensor data, social network feeds, news feeds, and blog posts.

Environment 100, depicted in FIG. 1, can run on a number of servers connected to each other by network 125 (e.g., a LAN or a WAN) in a cluster or other distributed system that can execute distributed-computing software (including Apache's Hadoop or other software based on Map-Reduce and/or Google File System), virtualization software (e.g., as provided by VMware, Citrix, Microsoft, etc.), load-balancing software, database software (e.g., SQL, NoSQL, etc.), web server software, etc. In turn, the distributed file system 132 can be connected (e.g., by a storage area network (SAN)) to persistent storage which stores (e.g., in a database or other file) data related to authentication, entitlements and provisioning. The servers themselves can include hardware consisting of one or more microprocessors (e.g., from the x86 family), volatile storage (e.g., RAM), and persistent storage (e.g., a hard disk or solid-state drive); and an operating system (e.g., Linux, Windows Server, Mac OS Server, etc.) that runs on the hardware.

Distributed file system 132 can offer a clustered file system for storing the logged searches 122. In one implementation, distributed file system 132 can also include user defined functions (UDFs) for custom processing and manipulation of logged searches 122. UDFs can include an “eval” function that allows parsing of a string using a substring, “filter” function that allows filtering of data based on specified parameters, “aggregate” function that performs aggregation operations on data sets, and “load” function that controls how data is loaded or stored. A sample user defined function follows:

[bbhujaval@bbhujabal-wsl] >> more h_get_contact_search_udf.pig
define LFV LogFieldValue(‘/user/bbhujabal/transforms.conf’);
A = LOAD ‘/user/bbhujabal/infiles/mod_jk_201207_sample.log’ using
PigStorage (‘”);
B = FOREACH A GENERATE TOTUPLE (*) as row;
fLogs = Filter B By (LFV(row, ‘logRecordType’) == ‘CS);

The logged searches 122 can be filtered and transformed by the extraction engine 134 through query processing that translates the input parameters to a script in a given UDF description language. The UDF description language can be in extensible markup language (XML) format or in any line delimited syntax. The extraction engine 134 can then read the generated script and automatically generate a customized UDF table and install it for access and processing within the distributed file system 132.

Extraction engine 134 can provide query-based analysis of search queries stored in logged searches 122 over nested-relational or semi-structured data. In some implementations, it can include query languages such as Pig, Impala, Jaql, Dremmel, Asterix, or Hive along with parallel distributed algorithms like MapReduce. It can parse the logged searches 122 to provide subsets of text sequences having certain attributes, which can be further processed in the evaluation engine 136. In one implementation, extraction engine 134 can run analytics such as clustering, classification and prediction over the logged searches 122.

Evaluation engine 136 can determine the number of results per query criteria that appear in one or more of the search logs over a recent time period (e.g., a most recent hour, day or week) as determined by timestamps associated with the queries in the search logs. If the number of results are below a threshold value, then the query criteria can be included in “low recall query queue,” which can be stored in the analytics store 138. In one implementation, the threshold value can be determined based on a reference ratio between the number of results for a given search across an entire database as compared to the proportionate number of expected results for a subset of the entire database. The threshold value can be a relative numerical estimate of the statistical likelihood of certain attributes of a population sample, according to one implementation. In another implementation, the threshold value can be specified by business intelligence and analytics experts.

Evaluation engine 136 can also determine the number of times a low recall query criteria appears in one or more of the search logs over a recent time period (e.g., a most recent hour, day or week) as determined by timestamps associated with the queries in the search logs. If a low recall query criteria appears an overall number of times that exceeds a threshold value, the low recall query criteria can be included in a “high demand query queue,” which can be stored in the analytics store 138. Furthermore, the low recall but high demand query criteria can be stratified based on geographical locations, which can be identified by the IP addresses of the clients that submitted the low recall but high demand query criteria or by the target areas of queries. The evaluation engine 136 can then calculate an estimation of the threshold value for a geographic location based on the frequency of the query criteria submitted from that geographic location.

Retrieval engine 128 can invoke the analytics store 138 to access the query criteria stored in “low recall query queue” and “high demand query queue.” It can then initiate assembly of additional contacts meeting the query criteria. Contacts can be assembled, for instance, by buying data, by crawling the Internet and aggregating data, by soliciting enrollment by running contests and the like.

Regarding different types of person-related data sources, access-controlled application programming interfaces (APIs) like Yahoo Boss, Facebook Open Graph, and Twitter Firehose can provide data, respectively, from Yahoo, Facebook, Twitter, and the like. Access controlled APIs can initialize sorting, processing and normalization of person-related data. Public Internet can provide person-related data from public sources such as first hand websites, blogs, web search aggregators, and social media aggregators. Social networking sites can provide person-related data from social media sources such as Twitter, Facebook, LinkedIn, and Klout.

Retrieval engine 128 can spider the person-related data sources to retrieve contact-related data, including web data associated with business-to-business contacts. In some implementations, it can extract a list of contacts from a master database and search person-related data sources in order to determine if social or web content is available for those contacts. If the person-related data sources provide positive matches to any of the contacts, the retrieval engine 128 can store the retrieved social or web content and business-to-business contacts in the contact provider 115.

### Message Sequence Chart

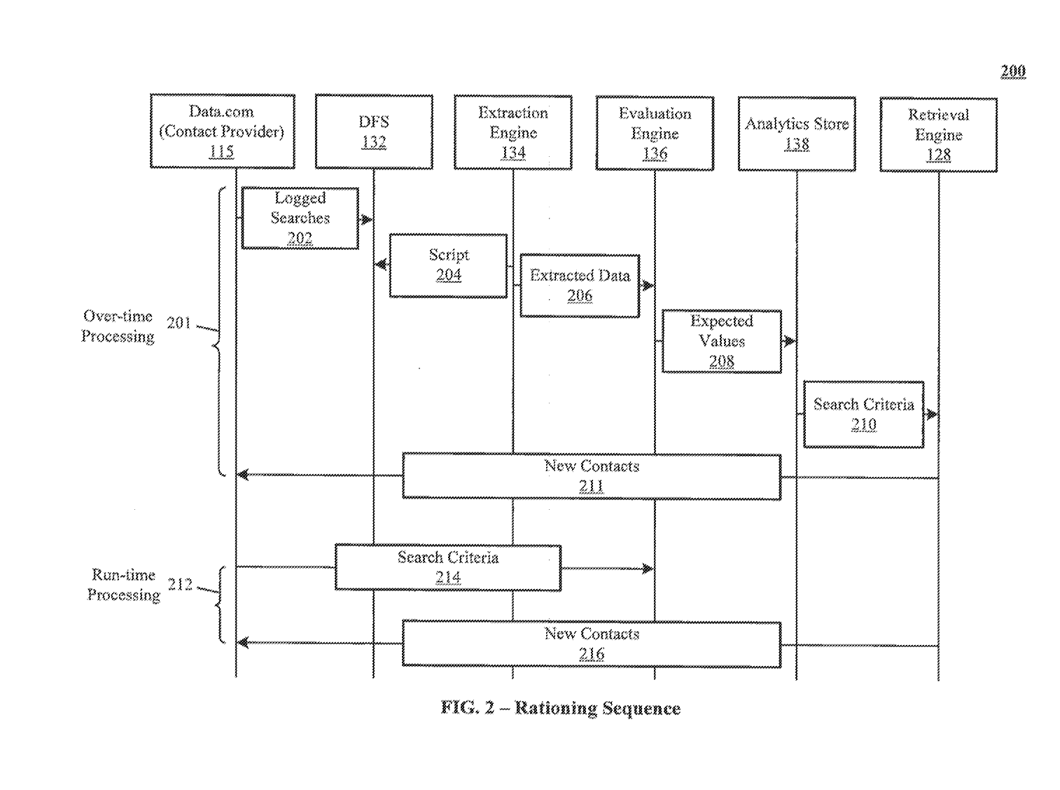

FIG. 2 is one implementation of a message sequence chart 200 of rationing data assembly resources. Other implementations may perform the exchanges in different orders and/or with different, fewer or additional exchanges than the ones illustrated in FIG. 2. Multiple exchanges can be combined in some implementations. For convenience, this sequence chart is described with reference to the system that carries out a method. The system is not necessarily part of the method.

Workflow 201 shows one implementation of over-time processing of logged searches 122 for rationing contact provider 115. At exchange 202, the contact provider 115 can forward the logged searches 202 to distributed file system 132 for storage. In one implementation, the logged searches 202 can specify the user ID of a user who initiates a “contact-related search query” along with other supplemental attributes of the contact-related search query. Examples of such attributes can include first names, last names, employer names, job functions, company names, geographic areas, industry code, social data, IP addresses of clients that submitted the search criteria, etc. A sample log file entry follows:

[Sun Jul 01 00:00:03 2012] 1796 lb 192.168.100.90 0.007538 POST
/api/getCompany.xml?orgid=jdf HTTP/1.1 201 ?orgid=jdf /api/
getCompany.xml
[Sun Jul 01 00:00:15 2012] 115 lb sfa.jigsaw.com 0.008657 GET
/api/getContact.xml?companyName=telvent&departments=
Operations&levels=VP&userid=005900000016zhd&orgid=
0&orderBy=lastname

At exchange 204, the extraction engine 134 can execute a script on the logged searches 202 to extract user desired data based on the UDFs specified by the user. The UDFs tables can first connect to the distributed file system 132, start up the script, which then can read the semi-structured files stored in the logged searches 202, perform data filtering, and send the extracted data to the evaluation engine 136 at exchange 206. In one implementation, a high-level procedural language such Apache Pig can be used for querying large semi-structured data sets logged in the logged searches 202 based on user specified query criteria. In other implementations, other scripting languages such as Impala, Jaql, Dremmel, Asterix, Hive, MapReduce, and the like can be used.

In one implementation, Pig Latin script can extract user desired information from logged searches 202 by specifying a sequence of data transformations such as merging data sets (join or aggregation), filtering them (sort), and applying user defined functions (UDFs) to semi-structured data sets. Pig Latin script allows extraction engine 134 to extract those records or attributes from a large set of logged files that a user desires to process in the evaluation engine 136. For instance, extraction engine 134 can extract company names and job functions from the above discussed sample log file entry. The extracted output is shown below:
companyName=telvent&departments=Operations&levels=VP

Evaluation engine 136 can determine the quantity of contacts retrieved per query criteria based on an expected value for number of responsive contacts specified in the search criteria. An expected value can be: inferred from a number of high demand search criteria, based on the frequency of unique queries with low recall search criteria or determined by the joint probability distribution of the concurrence of various elements specified in a search criteria. The evaluation engine 136 can then forward the expected values to the analytics store 138 at exchange 208.

At exchange 210, retrieval engine 128 can invoke the analytics store 138 to access the identified search criteria. It can then initiate compilation of additional contacts meeting the query, for instance, by buying data, by crawling the Internet and aggregating data, by soliciting enrollment by running contests and the like. The additional contacts can then be sent to the contact provider 115 at exchange 211.

Workflow 212 shows one implementation of real-time processing of logged searches for rationing contact provider 115. In this implementation, the search criteria for which the quantity of contacts returned is deficient compared to an expected value can be stored in stored in a separate cache. These search criteria can be directly sent to the retrieval engine 128 at exchange 214, which can aggregate, in real-time, additional contacts meeting the search criteria. The additional contacts can then be sent to the contact provider 115 at exchange 216.

### Customer Interface

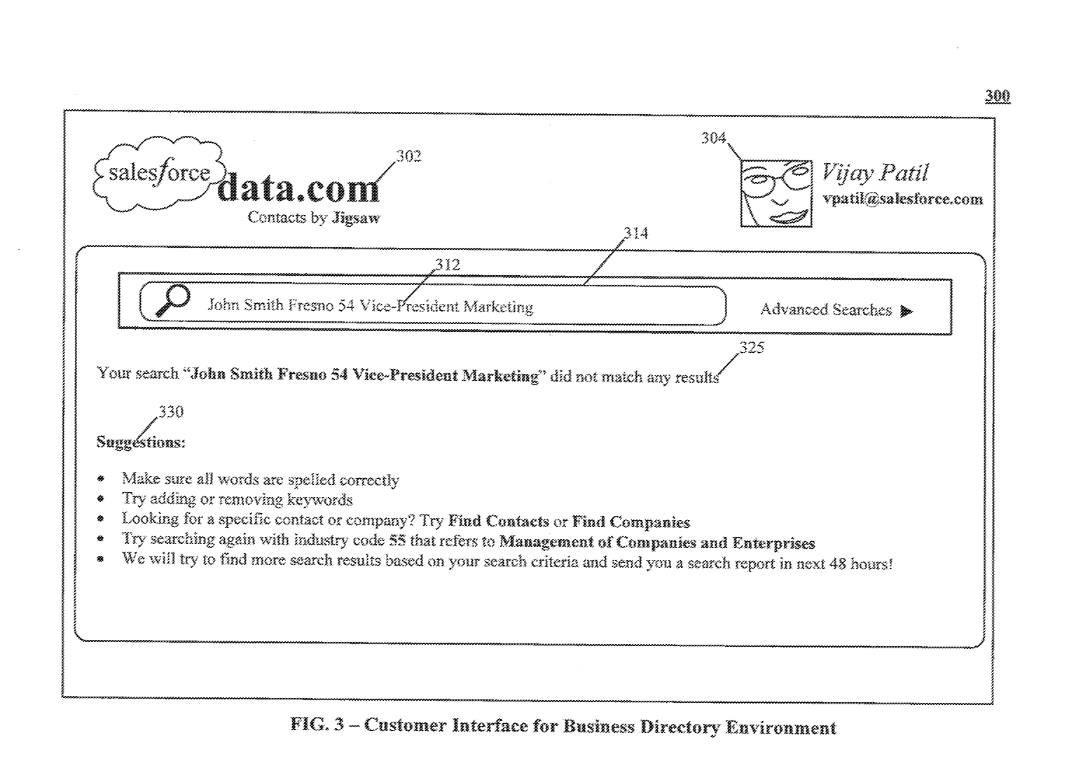

FIG. 3 illustrates a customer interface 300 of searching contacts across contact provider 115. FIG. 3 can include search tab 314, query criteria 312, result tab 325, and suggestions 330. In other implementations, customer interface 300 may not have the same widgets or screen objects as those listed above and/or may have other/different widgets or screen objects instead of, or in addition to, those listed above.

Customer interface 300 can provide an interface for searching contacts across contact provider 115 through query criteria 312. In one implementation, customer interface 300 can take one of a number of forms, including a dashboard interface, engagement console, and other interface, such as a mobile interface or summary interface.

Customer interface 300 can be hosted on a web-based or cloud-based application like data.com 302 and run on a computing device such as a personal computer, laptop computer, mobile device or any other hand-held computing device. It can also be hosted on a non-social local application running in an on-premise environment. In one implementation, customer interface 300 can be accessed from a browser running on a computing device. The browser can be Chrome, Internet Explorer, Firefox, Safari, etc. In another implementation, customer interface 300 can run as an engagement console on a computer desktop application primarily used for contact searching.

When a user 304 queries the contact provider 115 by specifying the query criteria 312 in search tab 314, the contact provider 115 can present the search results in the result tab 325. For instance, when query criteria 312, which includes a contact name “John Smith,” geographic area “Fresno,” industry code “54,” job function “vice-president,” and industry name “marketing,” is issued across the contact provider 115, the contact provider 115 may not retrieve any matching results and communicate that via the result tab 325.

In some implementations, if user 304 provides a job function that does not match an industry code or industry name also provided by the user 304, then the contact provider 115 can suggest to user 304 the industry codes or industry names that match the job function. For example, if user 304 searches for “head nurse Fresno 55 Marketing,” the contact provider 115 can identify that the job function “head nurse” does not match the marketing industry or its industry code. In this example, the contact provider 115 can suggest to user 304 the appropriate industry names and codes associated with the “head nurse” job function such as “nursing,” “medical sciences,” etc.

When a user specified query criteria, such as query criteria 312, does not produce any results, the contact provider 115 can initiate compilation of additional results that meet the query criteria 312, as explained above. After assembling additional results, the contact provider 115 can send a supplementary search report to user 304 that describes information related to the query criteria 312 like query text, query time stamp, original results along with an indication of the newly assembled results. In one implementation, the compilation of additional results and generation of supplementary search reports can occur when the number of results retrieved in response to a query criteria are lower than an expected value.

In another implementation, the contact provider 115 can make suggestions 330 to user 304 once the search is complete. Suggestions 330 can include asking user 304 to make sure that all words were spelled correctly and if the user 304 should try adding or removing some keywords. Other suggestions 330 can direct the user 304 to a web page that displays specific contacts or companies.

### Demand-Identification Records

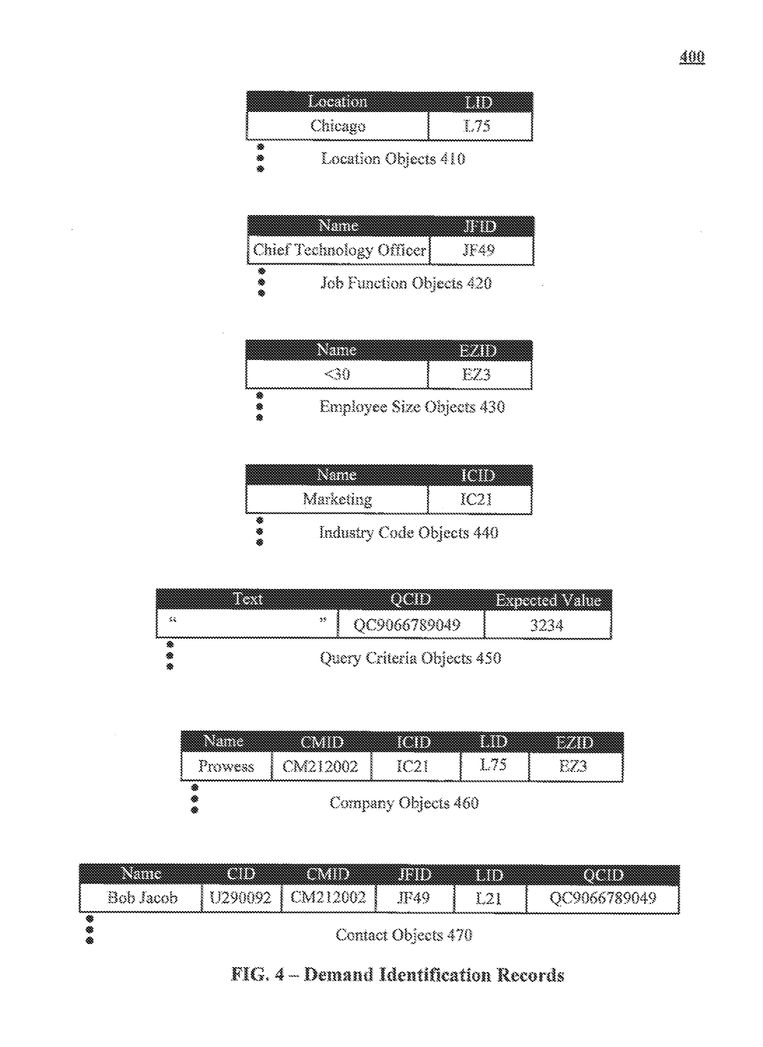

FIG. 4 shows one implementation 400 of a plurality of objects that can be used for rationing data assembly resources. As described above, this and other data structure descriptions that are expressed in terms of objects can also be implemented as tables that store multiple record or object types. Reference to objects is for convenience of explanation and not as a limitation on the data structure implementation. FIG. 4 shows location objects 410, job function objects 420, employee size objects 430, industry code objects 440, query criteria objects 450, company objects 460, and contact objects 470. Other implementations of the technology disclosed may not have the same objects, tables, entries or fields as those listed above and/or may have other/different objects, tables, entries or fields instead of, or in addition to, those listed above.

Contact provider 115 can specify geographic locations of companies and contacts using the location objects 410. In one implementation, location objects 410 can include columns that identify names of locations along with their location IDs referred to as “LID.” As shown in FIG. 4, objects 410 can uniquely identify a location as “Chicago” and assign it a LID of “L75.”

In another implementation, location objects 410 can have one or more of the following variables with certain attributes: REGION_ID being CHAR (15 BYTE), ORGANIZATION_ID being CHAR (15 BYTE), USER_ID being CHAR (15 BYTE), CREATED_BY being CHAR (15 BYTE), CREATED_DATE being DATE, and DELETED being CHAR (1 BYTE). In one implementation, new entries can be added chronologically with a new record ID, which can be incremented in order. The first key prefix can provide a key that is unique to a group of records, e.g., custom records (objects). The “organization” variable can provide an ID of an organization to which the record is related. The “created by” variable can track the user who is performing the action that results in the record. The “created date” variable can specify the time stamp of record creation. The deleted variable can indicate that the record was deleted, and thus the record is not generated.

Contact provider 115 can specify job functions of contacts using the job function objects 420. In one implementation, job function objects 420 can include columns that identify job functions along with their job function IDs referred to as “JFID.” As shown in FIG. 4, objects 420 can uniquely identify a job function as “chief technology officer” and assign it a JFID of “JF49.”

In another implementation, job function objects 420 can have one or more of the following variables with certain attributes: USER_ID being CHAR (15 BYTE), ORGANIZATION_ID being CHAR (15 BYTE), REGION_ID being CHAR (15 BYTE), CREATED_BY being CHAR (15 BYTE), CREATED_DATE being DATE, and DELETED being CHAR (1 BYTE).

Contact provider 115 can specify employee sizes of companies using the employee size objects 430. In one implementation, employee size objects 430 can include columns that identify employee sizes of companies along with their employee size IDs referred to as “EZID.” As shown in FIG. 4, objects 430 can uniquely identify an employee size as being less than thirty using the symbol “<30” and assign it an EZID of “EZ3.”

In another implementation, employee size objects 430 can have one or more of the following variables with certain attributes: RANGE_ID being CHAR (15 BYTE), ORGANIZATION_ID being CHAR (15 BYTE), REGION_ID being CHAR (15 BYTE), CREATED_BY being CHAR (15 BYTE), CREATED_DATE being DATE, and DELETED being CHAR (1 BYTE).

Contact provider 115 can use the industry code objects 440 to store industry codes in which companies can be stratified into. In one implementation, industry code objects 440 can include columns that identify industry codes along with their industry code IDs referred to as “ICID.” As shown in FIG. 4, objects 440 can uniquely identify an industry code as “IC21” that refers to “Marketing” industry.

In another implementation, industry code objects 440 can have one or more of the following variables with certain attributes: CLASSIFICATION_SYSTEM_ID being CHAR (15 BYTE), ORGANIZATION_ID being CHAR (15 BYTE), REGION_ID being CHAR (15 BYTE), CREATED_BY being CHAR (15 BYTE), CREATED_DATE being DATE, and DELETED being CHAR (1 BYTE).

When a query is issued to retrieve a contact from the contact provider 115 using a query criteria, the contact provider 115 can register that query criteria in the query criteria objects 450 along with the text of the query criteria and recall expected value of the query criteria as calculated by the evaluation engine 136. In one implementation, query criteria objects 450 can include columns that identify the query criteria along with their query IDs referred to as “QCID.” As shown in FIG. 4, objects 460 can uniquely identify a query's text along with its QCID as being “QC9066789049” and expected value being “3234.”

In another implementation, company objects 460 can have one or more of the following variables with certain attributes: USER_ID being CHAR (15 BYTE), ORGANIZATION_ID being CHAR (15 BYTE), VALUE_ID being CHAR (15 BYTE), CREATED_BY being CHAR (15 BYTE), CREATED_DATE being DATE, and DELETED being CHAR (1 BYTE).

Contact provider 115 can use the company objects 460 to store information related to companies for whom the contacts work for. In one implementation, company objects 460 can include columns that identify companies along with their company IDs referred to as “CMID.” As shown in FIG. 4, objects 460 can uniquely identify a company named “Prowess” that belongs to marketing industry, is located in Chicago and has an employee size of less than thirty.

In another implementation, company objects 460 can have one or more of the following variables with certain attributes: USER_ID being CHAR (15 BYTE), CODE_ID being CHAR (15 BYTE), REGION_ID being CHAR (15 BYTE), CREATED_BY being CHAR (15 BYTE), CREATED_DATE being DATE, and DELETED being CHAR (1 BYTE).

Contact provider 115 can include one or more contact databases such as contact objects 470, which provides a list of contacts. Contact objects 470 can also specify other characteristics of the contacts such as information related to their employers, their job functions and the current work locations of the contacts. In one implementation, it can also include a column that holds records related to the query criteria that retrieve the contacts from the contact provider 115.

In one implementation, contact objects 470 can include columns that specify names of contacts along with their contact IDs referred to as “CID.” As shown in FIG. 4, objects 470 can uniquely identify a contact with the name “Ben Jacob” and assign it a CID of “U290092.” The company for which this contact works can be identified through a company ID referred to as “CMID” and can be assigned a value of “CM212002.” The contact's job function can be identified using a job function ID called “JFID” and have a value of “JF49.” Also, the contact's current work location can be held in a column named “LID” with a field entry of “L21.” Furthermore, the query criteria used to search this contact across the contact provider 115 can be registered in a column named “QCID” and be identified with the ID “QC9066789049.”

In another implementation, contact objects 470 can have one or more of the following variables with certain attributes: USER_ID being CHAR (15 BYTE), ORGANIZATION_ID being CHAR (15 BYTE), QUERY_ID being CHAR (15 BYTE), CREATED_BY being CHAR (15 BYTE), CREATED_DATE being DATE, and DELETED being CHAR (1 BYTE).

### Flowchart of Rationing Data Assembly Resources

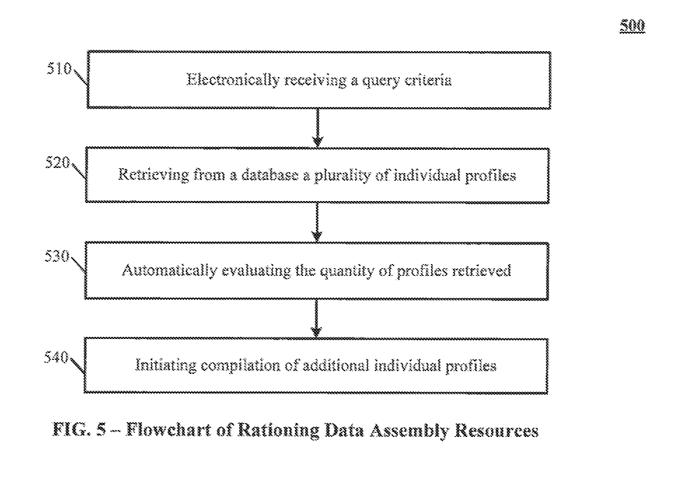

FIG. 5 illustrates a flowchart 500 of one implementation of rationing data assembly resources. Other implementations may perform the actions in different orders and/or with different, fewer or additional actions than the ones illustrated in FIG. 5. Multiple actions can be combined in some implementations. For convenience, this flowchart is described with reference to the system that carries out a method. The system is not necessarily part of the method.

At action 510, the contact provider 115 can electronically receive a query criteria. In one implementation, the query criteria can be specified by user 304 across a customer interface 300. In some implementations, query criteria can include a contact's first name, last name, email address, employer information, and work location.

In response to the query criteria issued at action 510, the contact provider 115 can retrieve a plurality of individual profiles at action 520 by identifying data objects in its contact databases that have data values matching the data values of data objects specified in the query criteria. If one or more data objects, such as a first name, last name, phone number, geographic area, industry code, job function, mailing address, standard industrial classification (SIC) number, or annual revenue, matches the query criteria, then the record that stores the matching data values can be returned. Furthermore, data values provided by the users can be compared with account names and metadata associated with records in addition to the contents of the records themselves.

After retrieving a plurality of individual profiles at action 520, the quantity of the retrieved profiles can be automatically evaluated against an expected value for population size of individuals responsive to the query criteria. In one implementation, the expected value can be based on at least an evaluation of number of local companies in the geographic area having the industry code and having related industry codes. The expected value can also be further based on an evaluation of employee sizes of the local companies and an estimate of number of employees having the queried job function. In another implementation, the expected value can be further based on an evaluation of whether employees of the local companies who have the queried job function are present in the geographic area, as opposed to being located at a different company site.

The expected value can also be based on at least an evaluation of a frequency of queries received for at least the geographic area, industry code and job function. In some implementations, this evaluation can be made using statistical models such as joint probability distribution that estimates the likelihood of concurrence of various elements specified in a search criteria. Furthermore, it can be based on the frequency of queries made by unique requestors. In one implementation, the count of unique requestors can be based on IP addresses or cookies logged by an access logging system that compares the count of unique IP addresses or unique cookies to the number of visits.

At action 540, the retrieval engine 128 can initiate compilation of additional individual profiles meeting the query criteria by aggregating business-to-business data and social data from crawling person-related data sources, soliciting user interest during advertising campaigns through evaluation forms, contents and incentives and/or purchasing pre-packaged person-related content repositories such as Jigsaw, Dun & Bradstreet, etc.

### Flowchart of Identifying a New Prototype Query Criteria

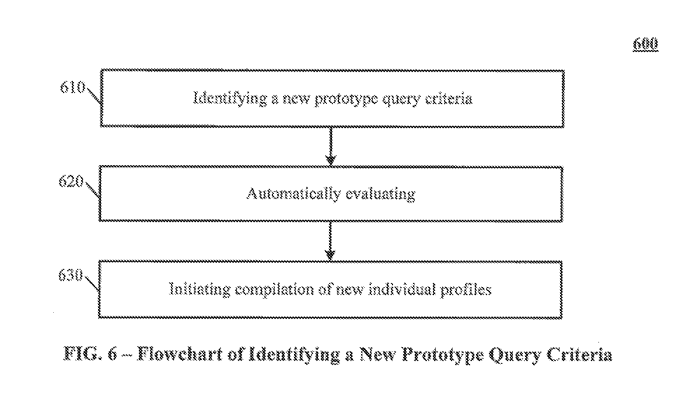

FIG. 6 is a flowchart 600 of one implementation of identifying a new prototype query criteria. Other implementations may perform the actions in different orders and/or with different, fewer or additional actions than the ones illustrated in FIG. 6. Multiple actions can be combined in some implementations. For convenience, this flowchart is described with reference to the system that carries out a method. The system is not necessarily part of the method.

At action 610, content provider 115 can identify a new prototype query criteria from a are received query criteria that did not retrieve any contacts. Evaluation engine 136 can determine the number of results per query criteria that appear in one or more of the search logs over a recent time period (e.g., a most recent hour, day or week) as determined by timestamps associated with the queries in the search logs. If the number of results are below a threshold value, then the query criteria can be included in “low recall query queue,” which can be stored in the analytics store 138.

In one implementation, the threshold value can be determined based on a reference ratio between the number of results for a given search across an entire database as compared to the proportionate number of expected results for a subset of the entire database. The threshold value can be a relative numerical estimate of the statistical likelihood of certain attributes of a population sample, according to one implementation. In another implementation, the threshold value can be specified by business intelligence and analytics experts.

At action 620, the evaluation engine 136 can automatically evaluate whether the new prototype query is sensible and expected to return individual profiles. In some implementations, if a user provides a job function that does not match an industry code or industry name also provided by the user, then the contact provider 115 can suggest to the user the industry codes or industry names that match the job function.

At action 630, the retrieval engine 128 can initiate assembly of new contacts meeting the new prototype query criteria by buying data, by crawling the Internet and aggregating data, by soliciting enrollment by running contests and the like.

### Computer System

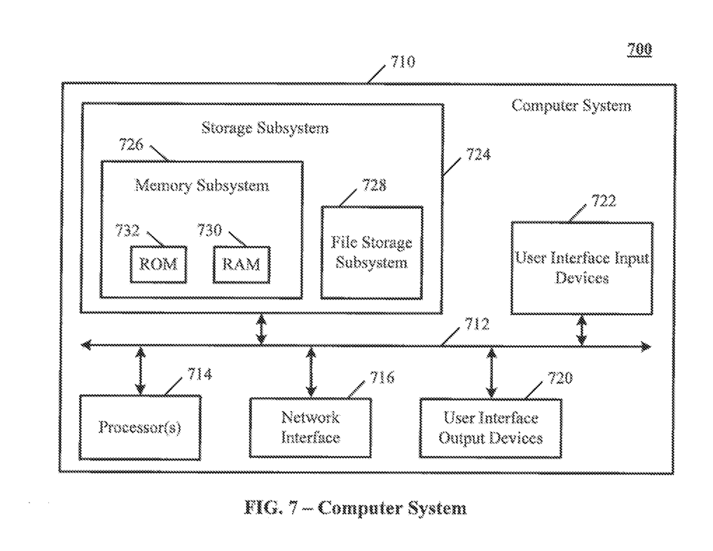

FIG. 7 is a block diagram of an example computer system of rationing data assembly resources. Computer system 710 typically includes at least one processor 714 that communicates with a number of peripheral devices via bus subsystem 712. These peripheral devices can include a storage subsystem 724 including, for example, memory devices and a file storage subsystem, user interface input devices 722, user interface output devices 720, and a network interface subsystem 717. The input and output devices allow user interaction with computer system 710. Network interface subsystem 717 provides an interface to outside networks, including an interface to corresponding interface devices in other computer systems.

User interface input devices 722 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 710.

User interface output devices 720 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 710 to the user or to another machine or computer system.

Storage subsystem 724 stores programming and data constructs that provide the functionality of some or all of the modules and methods described herein. These software modules are generally executed by processor 714 alone or in combination with other processors.

Memory 727 used in the storage subsystem can include a number of memories including a main random access memory (RAM) 730 for storage of instructions and data during program execution and a read only memory (ROM) 732 in which fixed instructions are stored. A file storage subsystem 728 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 728 in the storage subsystem 724, or in other machines accessible by the processor.

Bus subsystem 712 provides a mechanism for letting the various components and subsystems of computer system 710 communicate with each other as intended. Although bus subsystem 712 is shown schematically as a single bus, alternative implementations of the bus subsystem can use multiple busses.

Computer system 710 can be of varying types including a workstation, server, computing cluster, blade server, server farm, or any other data processing system or computing device. Due to the ever-changing nature of computers and networks, the description of computer system 710 depicted in FIG. 7 is intended only as one example. Many other configurations of computer system 710 are possible having more or fewer components than the computer system depicted in FIG. 7.

### Particular Implementations

In one implementation, a method is described from the perspective of a server receiving messages from a user software. The method includes rationing data assembly resources. It includes electronically receiving a query criteria for retrieving individual profile information and retrieving from a database a plurality of individual profiles responsive to the query criteria. It also includes automatically evaluating the quantity of profiles retrieved against an expected value for population size of individuals responsive to the query criteria and reporting a need to assemble additional individual profiles, responsive to an evaluation that the quantity of profiles returned is deficient compared to the expected value.

This method and other implementations of the technology disclosed can each optionally include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations such as rationing environment, message sequence chart, customer interface, rationing records, etc.

The method further includes the query criteria including a geographic area, industry code and job function. It includes the expected value being based on at least an evaluation of number of local companies in the geographic area having a queried industry code and having related industry codes.

The method further includes the expected value being further based on an evaluation of employee sizes of the local companies and an estimate of number of employees having the queried job function. It also includes the expected value being further based on an evaluation of whether employees of the local companies who have the queried job function are present in the geographic area, as opposed to being located remotely.

The method further includes the expected value being based on at least an evaluation of a frequency of queries received for at least the geographic area, industry code and job function. It includes the expected value being further based on the frequency of queries by unique requestors.

The method further includes wherein the compilation of additional individual profiles includes at least one of aggregating business-to-business data and social data from crawling person-related data sources, soliciting user interest during advertising campaigns or purchasing pre-packaged person-related content repositories.

The method further includes in response to query criteria that do not retrieve any individual profiles, identifying a new prototype query criteria, automatically evaluating whether the new prototype query is sensible and expected to return individual profiles and initiating compilation of new individual profiles meeting at least the new query criteria.

The method further includes wherein the compilation of new individual profiles includes at least one of aggregating business-to-business data and social data from crawling person-related data sources, soliciting user interest during advertising campaigns or purchasing pre-packaged person-related content repositories.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

1. A method for rationing data assembly resources, the method including:
electronically receiving a query criteria for retrieving individual profile information;
retrieving from a database a plurality of individual profiles responsive to the query criteria;
automatically evaluating a quantity of the profiles retrieved against an expected value for a population size of individuals responsive to the query criteria; and
reporting a need to assemble additional individual profiles, responsive to an evaluation that the quantity of profiles returned is deficient compared to the expected value.

2. The method of claim 1, wherein the query criteria include a geographic area, industry code and job function.

3. The method of claim 2, wherein the expected value is based on at least an evaluation of a number of local companies in the geographic area having a queried industry code and having related industry codes.

4. The method of claim 3, wherein the expected value is further based on an evaluation of employee sizes of the local companies and an estimate of number of employees having a queried job function.

5. The method of claim 4, wherein the expected value is further based on an evaluation of whether employees of the local companies who have the queried job function are present in the geographic area, as opposed to being located remotely.

6. The method of claim 1, wherein the expected value is based on at least an evaluation of a frequency of queries received for at least a geographic area, industry code and job function.

7. The method of claim 6, wherein the expected value is further based on the frequency of queries by unique requestors.

8. The method of claim 1, wherein assembling additional individual profiles includes at least one of:
aggregating business-to-business data and social data from crawling person-related data sources;
soliciting user interest during advertising campaigns; or
purchasing pre-packaged person-related content repositories.

9. The method of claim 1, further including
in response to query criteria that do not retrieve any individual profiles, identifying a new prototype query criteria;
automatically evaluating whether the new prototype query is sensible and expected to return individual profiles; and
initiating compilation of new individual profiles meeting at least the new query criteria.

10. The method of claim 9, wherein the compilation of new individual profiles includes at least one of:
aggregating business-to-business data and social data from crawling person-related data sources;
soliciting user interest during advertising campaigns; or
purchasing pre-packaged person-related content repositories.

11. A computer system for rationing data assembly resources, the system including:
a processor and a computer readable storage medium storing computer instructions configured to cause the processor to:
electronically receive a query criteria for retrieving individual profile information;
retrieve from a database a plurality of individual profiles responsive to the query criteria;
automatically evaluate a quantity of the profiles retrieved against an expected value for a population size of individuals responsive to the query criteria; and
report a need to assemble additional individual profiles, responsive to an evaluation that the quantity of profiles returned is deficient compared to the expected value.

12. The system of claim 11, wherein the query criteria include a geographic area, industry code and job function.

13. The system of claim 12, wherein the expected value is based on at least an evaluation of a number of local companies in the geographic area having a queried industry code and having related industry codes.

14. The system of claim 13, wherein the expected value is further based on an evaluation of employee sizes of the local companies and an estimate of number of employees having a queried job function.

15. The system of claim 14, wherein the expected value is further based on an evaluation of whether employees of the local companies who have the queried job function are present in the geographic area, as opposed to being located remotely.

16. The system of claim 11, wherein the expected value is based on at least an evaluation of a frequency of queries received for at least a geographic area, industry code and job function.

17. The system of claim 16, wherein the expected value is further based on the frequency of queries by unique requestors.

18. The system of claim 11, wherein assembling additional individual profiles includes at least one of:
aggregating business-to-business data and social data from crawling person-related data sources;
soliciting user interest during advertising campaigns; or
purchasing pre-packaged person-related content repositories.

19. The system of claim 11, further configured to cause the processor to:
in response to query criteria that do not retrieve any individual profiles, identify a new prototype query criteria;
automatically evaluate whether the new prototype query is sensible and expected to return individual profiles; and
initiate compilation of new individual profiles meeting at least the new query criteria.

20. The system of claim 19, wherein the compilation of new individual profiles includes at least one of:
aggregating business-to-business data and social data from crawling person-related data sources;
soliciting user interest during advertising campaigns; or
purchasing pre-packaged person-related content repositories.
